(19) United States
(12) Patent Application Publication
(10) Pub. No.: US 2026/0322788 A1
(43) Pub. Date: Oct. 15, 2026

(54) METHOD AND SYSTEM FOR HYBRID GENERATIVE ARTIFICIAL INTELLIGENCE DEPLOYMENT USING INTERMEDIATE DATA AND DESTINATION EDGE DEVICE PRESENTATION

(71) Applicant: MEDIATEK INC., Hsinchu City (TW)

(72) Inventors: Chun-Nan Chen, Hsinchu City (TW); Jin-Xiao Wu, Hsinchu City (TW); He-Yuan Lin, Hsinchu City (TW); Wei-Hsun Lin, Hsinchu City (TW); You-Kuang Chen, San Jose, CA (US)

(73) Assignee: MEDIATEK INC., Hsinchu City (TW)

(21) Appl. No.: 19/647,905

(22) Filed: Apr. 15, 2026

Related U.S. Application Data
(60) Provisional application No. 63/788,852, filed on Apr. 15, 2025.

(51) Int. Cl. H04L 9/40; G06F 16/903; G06F 16/9038

(52) U.S. Cl. CPC H04L 63/0428; G06F 16/90335; G06F 16/9038

(57) ABSTRACT

A method for operating a hybrid Generative Artificial Intelligence (GAI) deployment, performed by an edge device, includes receiving original content; generating intermediate data by converting data of the original content; and transmitting the intermediate data from the edge device to a cloud server to cause the cloud server to generate response data by a cloud service based on the intermediate data and to transmit the response data from the cloud server to a destination edge device for presentation. The destination edge device is the edge device or another edge device different from the edge device.

### CROSS REFERENCE TO RELATED APPLICATIONS

This application claims the benefit of U.S. Provisional Application No. 63/788,852, filed on Apr. 15, 2025. The content of the application is incorporated herein by reference.

### BACKGROUND

Generative Artificial Intelligence (GAI) has been integrated into everyday consumer devices and services, including televisions, set-top boxes, mobile phones, tablets, and personal computers, to support interactive functions such as content understanding, language translation, summarization, and context-related information presentation.

In some deployments, a device transmits content to a remote computing platform so that the remote computing platform can perform GAI processing and return a result for presentation at the device. Such an approach can raise practical concerns. For example, transmitting content that reflects a user's viewing or listening activity can increase privacy exposure. Further, reliance on network connectivity can introduce latency and variability in response time, and can increase bandwidth usage and operational costs.

In other deployments, a device performs more processing locally. While local processing can reduce reliance on network connectivity and limit the amount of content transmitted off-device, local execution of GAI-related workloads can require substantial compute resources, memory, and power. These requirements can increase device cost and can limit the ability of price-sensitive devices to support GAI workloads at desired performance levels. In addition, as models and services evolve, local implementations can face constraints in maintaining performance or capability without frequent device-side upgrades.

Accordingly, it is a design issue to provide a method and system that support GAI-related interactions in daily-use devices while controlling privacy exposure, latency, and resource usage.

### SUMMARY

In an embodiment, a method for operating a hybrid Generative Artificial Intelligence (GAI) deployment is disclosed. The method comprises receiving original content by an edge device; generating intermediate data by converting data of the original content; and transmitting the intermediate data to a cloud server to cause the cloud server to generate response data by a cloud service based on the intermediate data and to transmit the response data from the cloud server to a destination edge device for presentation, wherein the destination edge device is the edge device or another edge device different from the edge device.

In another embodiment, an edge device for a hybrid Generative Artificial Intelligence (GAI) deployment is disclosed. The edge device comprises a communication interface, a memory storing instructions, and at least one processor coupled to the communication interface and the memory, wherein the at least one processor is configured to receive original content, generate intermediate data by converting data of the original content, and transmit, via the communication interface, the intermediate data to a cloud server to cause the cloud server to generate response data by a cloud service based on the intermediate data and to transmit the response data to a destination edge device for presentation, wherein the destination edge device is the edge device or another edge device different from the edge device.

In another embodiment, a method for providing a hybrid Generative Artificial Intelligence (GAI) service, performed by a cloud server, is disclosed. The method comprises receiving, from a first edge device over a network, intermediate data, wherein the intermediate data is derived from original content processed by the first edge device; generating response data by a cloud service hosted on the cloud server based on the intermediate data; and transmitting the response data to a destination edge device to cause the destination edge device to present the response data, wherein the destination edge device is the first edge device or a second edge device different from the first edge device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic block diagram of a hybrid Generative Artificial Intelligence (GAI) deployment system according to an embodiment.

FIG. 2 is a flowchart of a method for operating the hybrid GAI deployment system in FIG. 1 by transmitting metadata as intermediate data according to an embodiment.

FIG. 3 is a flowchart of a method for operating the hybrid GAI deployment system in FIG. 1 by transmitting feature information as intermediate data according to an embodiment.

FIG. 4 is a flowchart of a method for operating the hybrid GAI deployment system in FIG. 1 by transmitting sampled data as intermediate data according to an embodiment.

FIG. 5 is a schematic block diagram of a hybrid GAI deployment system in which an edge device transmits intermediate data to a cloud server and a destination edge device receives response data from the cloud server according to an embodiment.

FIG. 6 is a flowchart of a method for operating the hybrid GAI deployment system in FIG. 5 according to an embodiment.

FIG. 7 is a flowchart of a method for operating the hybrid GAI deployment system according to an embodiment.

### DETAILED DESCRIPTION

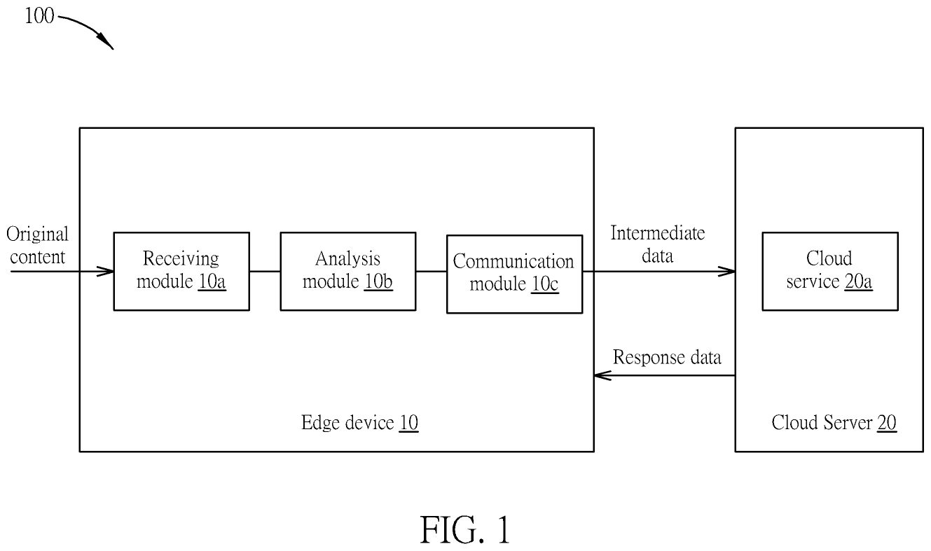

FIG. 1 is a schematic block diagram of a hybrid Generative Artificial Intelligence (GAI) deployment system 100 according to an embodiment. As shown in FIG. 1, the hybrid GAI deployment system 100 includes an edge device 10 and a cloud server 20. The edge device 10 includes a receiving module 10a, an analysis module 10b, and a communication module 10c. Although the edge device 10 is described herein as including functional modules such as the receiving module 10a, the analysis module 10b, and the communication module 10c, these modules can be implemented in hardware, software, or a combination thereof. In a hardware-based implementation, the edge device 10 includes a communication interface, a memory storing instructions, and at least one processor coupled to the communication interface and the memory. The at least one processor is configured to execute the instructions stored in the memory to perform the operations and functions of the modules described herein, such as a CPU (central processing unit), a graphics processing unit (GPU), an APU (Accelerated Processing Unit. Alternatively, these modules can be implemented as dedicated hardware circuits, such as an Application-Specific Integrated Circuit (ASIC) or a Neural Processing Unit (NPU).

The cloud server 20 includes a cloud service 20a. The hybrid GAI deployment system 100 supports a data flow in which original content is provided to the edge device 10, intermediate data is transmitted from the edge device 10 to the cloud server 20, and response data is transmitted from the cloud server 20 to a destination edge device for presentation.

The receiving module 10a is configured to receive the original content. The original content includes at least one of audio content, image content, or video content. The edge device 10 corresponds to a consumer device that is used in daily life. The consumer device includes at least one of a television, a set-top box, a projector, a mobile phone, a tablet, a personal computer, or a laptop. The receiving module 10a can acquire the original content from a local source or from a network source, and the receiving module 10a can provide the original content to the analysis module 10b for subsequent processing.

The analysis module 10b is configured to generate the intermediate data by converting data of the original content, such as processing the original content. The operation of processing or converting data of the original content serves multiple technical purposes. For example, converting the data reduces the data payload size and the required transmission bandwidth, lowers the transmission latency, and protects the privacy of the original content by keeping sensitive raw data locally at the edge device 10. Additionally, the conversion can format the data into specific structures, such as tensors or embeddings, that are directly compatible with the input format of a Generative Artificial Intelligence (GAI) model hosted on the cloud server 20. The intermediate data is data derived from the original content and is arranged for transmission to the cloud server 20. The intermediate data includes at least one form among metadata, feature information, or sampled data. The metadata includes meaningful information identified and extracted from the original content. The meaningful information includes at least one of an identity of a person, an identity of a celebrity, a character trait, a landmark, a scene, or a sale item that appears in the original content. The feature information includes attributes or characteristics derived from the original content that are usable for identifying metadata at the cloud server 20. The sampled data includes data produced by sampling the original content, and the sampled data includes down-sampled data generated by reducing at least one of a spatial resolution of the original content or a temporal sampling frequency of the original content. The analysis module 10b can generate the intermediate data by performing an analysis operation on the original content. The analysis operation includes at least one of object detection, text detection, feature extraction, speech-to-text conversion, or a transformer-based conversion that produces token-form data derived from the original content. The analysis module 10b can select the at least one form among the metadata, the feature information, or the sampled data as the intermediate data based on an operating condition of the edge device 10. The operating condition includes at least one of an available computing resource of the edge device 10 or a network condition between the edge device 10 and the cloud server 20.

For example, the available computing resource of the edge device 10 represents a capability of the edge device 10 to perform an analysis operation for generating the intermediate data within a target time and a target power budget. The available computing resource can be characterized by one or more resource indicators, including a processor utilization of the edge device 10, an available memory capacity of the edge device 10, an availability of a hardware accelerator for executing a conversion operation, a power or thermal constraint of the edge device 10, or a task-queue load of the edge device 10. The analysis module 10b can acquire the one or more resource indicators from a resource monitor of the edge device 10 and can determine the available computing resource based on the one or more resource indicators. The analysis module 10b can use the available computing resource as a component of the operating condition for selecting at least one form among the metadata, the feature information, or the sampled data as the intermediate data.

The network condition between the edge device 10 and the cloud server 20 represents a communication state that affects transmission of the intermediate data and delivery of the response data. The network condition can be characterized by one or more communication indicators, including an estimated available bandwidth, a round-trip latency, a packet loss rate, a retransmission rate, a jitter level, or a signal-quality indicator associated with a network interface of the edge device 10. The communication module 10c can acquire the one or more communication indicators by monitoring network traffic, measuring message delivery timing, or reading a link-quality report provided by the network interface. The analysis module 10b can determine the network condition based on the one or more communication indicators and can use the network condition as a component of the operating condition for selecting at least one form among the metadata, the feature information, or the sampled data as the intermediate data.

To select the intermediate data format dynamically, the analysis module 10b can apply threshold-based logic. In a first scenario, when the edge device 10 has a battery level below a predetermined power threshold (e.g., below 20%) or when the network bandwidth exceeds a high-speed threshold, the analysis module 10b selects the sampled data format (e.g., down-sampling) to offload the computational burden to the cloud server 20. In a second scenario, when the network bandwidth is below a predetermined bandwidth threshold (e.g., in a weak signal area) but the available computing resource is high (e.g., a Neural Processing Unit (NPU) is available locally), the analysis module 10b selects the feature information format or the metadata format to extract key features locally, thereby transmitting only a minimal data payload to the cloud server 20.

The communication module 10c is configured to transmit the intermediate data from the edge device 10 to the cloud server 20. The communication module 10c is further configured to receive the response data from the cloud server 20. The communication module 10c can encrypt the intermediate data before transmitting the intermediate data to the cloud server 20. The edge device 10 can include a user interface configured to receive a user input indicating whether to transmit the intermediate data to the cloud server 20. The user input indicating whether to transmit can be received via a touch button, a voice command, or a gesture. The communication module 10c can transmit the intermediate data to the cloud server 20 in response to the user input indicating to transmit the intermediate data to the cloud server 20.

For example, after the intermediate data is generated, the user interface can display a graphical user interface (GUI) dialog box prompting, ‘Do you allow the anonymized feature data to be uploaded to the cloud to generate an AI response? (Yes/No).’ Alternatively, the user interface can utilize a voice assistant to verbally ask the user for transmission permission. The communication module 10c executes the transmission only in response to receiving an affirmative user input (e.g., a user input indicating ‘Yes’ via a touch button, a voice command, or a gesture), thereby providing a robust privacy protection mechanism.

The cloud service 20a is configured to generate the response data based on the intermediate data. In a configuration in which the intermediate data includes metadata, the cloud service 20a generates the response data based on the metadata. In a configuration in which the intermediate data includes feature information, the cloud service 20a identifies metadata based on the feature information, and the cloud service 20a generates the response data based on the metadata. In a configuration in which the intermediate data includes sampled data, the cloud service 20a identifies metadata corresponding to the sampled data, and the cloud service 20a generates the response data based on the metadata. The response data includes a cloud inference result generated by the cloud service 20a based on the intermediate data. The response data includes at least one of related information associated with the metadata or a recommendation associated with the metadata. The cloud service 20a can generate the response data based on historical interactions and preferences associated with a user, when such historical interactions and preferences are available to the cloud service 20a.

The generation of the response data at the cloud server 20 can be performed using a Generative Artificial Intelligence (GAI) model, such as a Large Language Model (LLM), a generative vision model, or a multimodal foundation model. When the intermediate data includes feature information or sampled data, the cloud service 20a can perform a two-stage generation process. First, the cloud service 20a utilizes a lightweight classifier or a recognition network to identify the metadata corresponding to the feature information or the sampled data. Second, the cloud service 20a inputs the identified metadata as prompts into the computationally intensive GAI model to generate the final response data, such as a synthesized text summary, generated images, or a contextual recommendation.

The cloud server 20 is configured to transmit the response data to a destination edge device. In one configuration, the destination edge device is the edge device 10. In another configuration, the destination edge device is another edge device different from the edge device 10. The destination edge device is configured to display the response data. When the destination edge device is the edge device 10, the edge device 10 presents the response data. When the destination edge device is the other edge device different from the edge device 10, the other edge device presents the response data.

It should be noted that ‘presentation’ or ‘presenting’ the response data on the destination edge device is not limited to displaying visual content on a screen. Depending on the hardware capabilities of the destination edge device, presenting the response data can include displaying text or images, playing audio content (e.g., outputting voice synthesis via a smart speaker), providing haptic feedback (e.g., generating vibration patterns on a smartwatch), or providing any multimodal combination thereof.

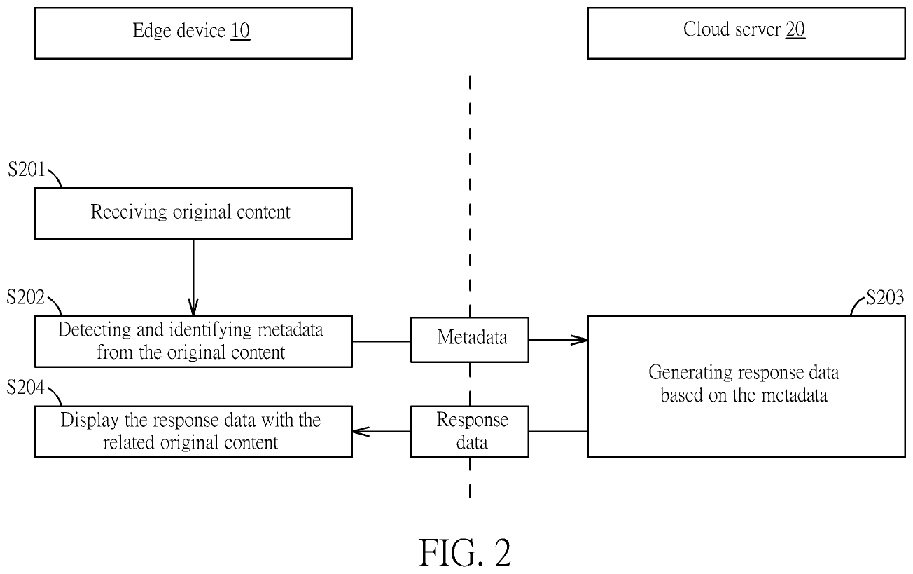

FIG. 2 is a flowchart of a method for operating the hybrid GAI deployment system 100 in FIG. 1 by transmitting metadata as intermediate data according to an embodiment. FIG. 2 illustrates a metadata-based operation between the edge device 10 and the cloud server 20. As shown in FIG. 2, the edge device 10 receives original content at step S201. The original content includes at least one of audio content, image content, or video content, as previously described with reference to FIG. 1. The edge device 10 can receive the original content through the receiving module 10a.

At step S202, the edge device 10 detects and identifies metadata from the original content. The edge device 10 can perform step S202 by the analysis module 10b. The metadata includes meaningful information identified and extracted from the original content. In some configurations, the metadata is associated with at least one of an identity of a person, an identity of a celebrity, a character trait, a landmark, a scene, or a sale item that appears in the original content. The edge device 10 generates intermediate data by converting data of the original content, and in the operation of FIG. 2, the intermediate data includes the metadata generated at step S202.

After the metadata is generated, the edge device 10 transmits the metadata to the cloud server 20 as the intermediate data. The edge device 10 can transmit the intermediate data by the communication module 10c. In some configurations, the communication module 10c encrypts the intermediate data before transmitting the intermediate data to the cloud server 20, as previously described with reference to FIG. 1. In some configurations, the edge device 10 receives a user input indicating whether to transmit the intermediate data to the cloud server 20, and the edge device 10 transmits the intermediate data to the cloud server 20 in response to the user input indicating to transmit the intermediate data to the cloud server 20, as previously described with reference to FIG. 1.

At step S203, the cloud server 20 generates response data based on the metadata. The cloud server 20 can perform step S203 by the cloud service 20a. In some configurations, the cloud service 20a generates the response data as a cloud inference result based on the metadata. In some configurations, the response data includes related information associated with the metadata, or a recommendation associated with the metadata. After the response data is generated, the cloud server 20 transmits the response data to a destination edge device. In the operation of FIG. 2, the destination edge device is the edge device 10.

At step S204, the edge device 10 presents the response data with related original content. For example, the edge device 10 can present the response data while the related original content is being played or presented, so that the response data is contextually associated with the original content that gave rise to the metadata. The operation of FIG. 2 forms a closed loop in which the edge device 10 converts the original content into intermediate data in a metadata form, the cloud service 20a generates response data based on the metadata, and the response data is returned for presentation at the edge device 10.

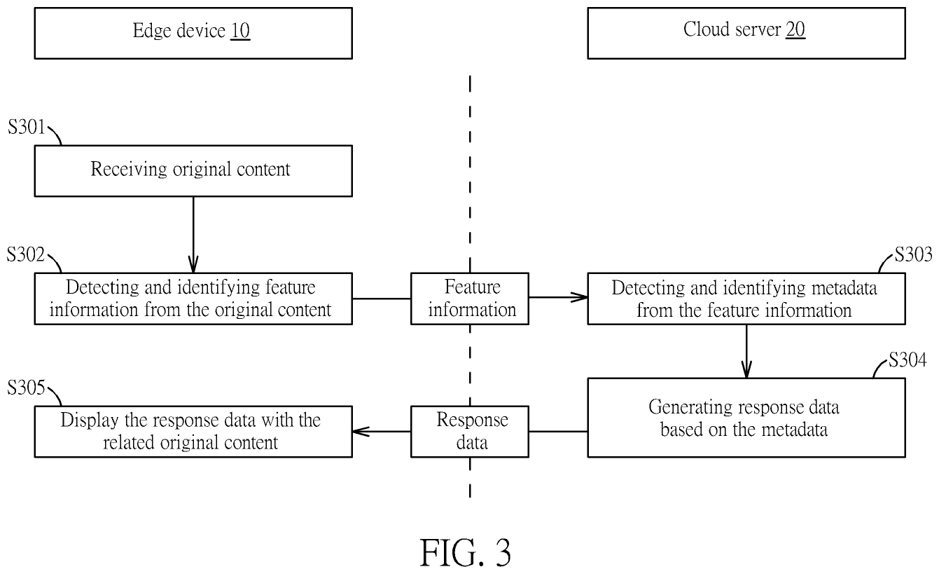

FIG. 3 is a flowchart of a method for operating the hybrid GAI deployment system 100 in FIG. 1 by transmitting feature information as intermediate data according to an embodiment. FIG. 3 illustrates an operation in which the edge device 10 generates intermediate data in a feature information form, the cloud server 20 derives metadata based on the feature information, and the cloud service 20a generates response data based on the metadata. As shown in FIG. 3, the edge device 10 receives original content at step S301. The edge device 10 can receive the original content through the receiving module 10a, as previously described with reference to FIG. 1. The original content includes at least one of audio content, image content, or video content.

At step S302, the edge device 10 detects and identifies feature information from the original content. The edge device 10 can perform step S302 by the analysis module 10b. Feature information refers to attributes or characteristics derived from the original content that are usable for identifying metadata at the cloud server 20. In some configurations, the feature information includes token-form data, feature vectors, region descriptors, object-related features, text-region features, or a combination thereof. The edge device 10 generates the intermediate data by converting data of the original content, and in the operation of FIG. 3, the intermediate data includes the feature information generated at step S302.

After the feature information is generated, the edge device 10 transmits the feature information to the cloud server 20 as the intermediate data. The edge device 10 can transmit the intermediate data by the communication module 10c, as previously described with reference to FIG. 1. In some configurations, the communication module 10c encrypts the intermediate data before transmitting the intermediate data to the cloud server 20. In some configurations, the edge device 10 receives a user input indicating whether to transmit the intermediate data to the cloud server 20, and the edge device 10 transmits the intermediate data to the cloud server 20 in response to the user input indicating to transmit the intermediate data to the cloud server 20.

At step S303, the cloud server 20 detects and identifies metadata from the feature information. The cloud server 20 can perform step S303 by the cloud service 20a. The metadata includes meaningful information identified and extracted based on the feature information. The meaningful information includes at least one of an identity of a person, an identity of a celebrity, a character trait, a landmark, a scene, or a sale item that appears in the original content.

At step S304, the cloud server 20 generates response data based on the metadata. The cloud server 20 can perform step S304 by the cloud service 20a. The response data includes a cloud inference result generated based on the metadata. In some configurations, the response data includes related information associated with the metadata or a recommendation associated with the metadata. After the response data is generated, the cloud server 20 transmits the response data to a destination edge device. In the operation of FIG. 3, the destination edge device is the edge device 10.

At step S305, the edge device 10 presents the response data with related original content. For example, when the original content includes a portion that is associated with the metadata, the edge device 10 can present the response data while the related original content is being played or presented, so that the response data is contextually associated with the original content that gave rise to the feature information and the metadata.

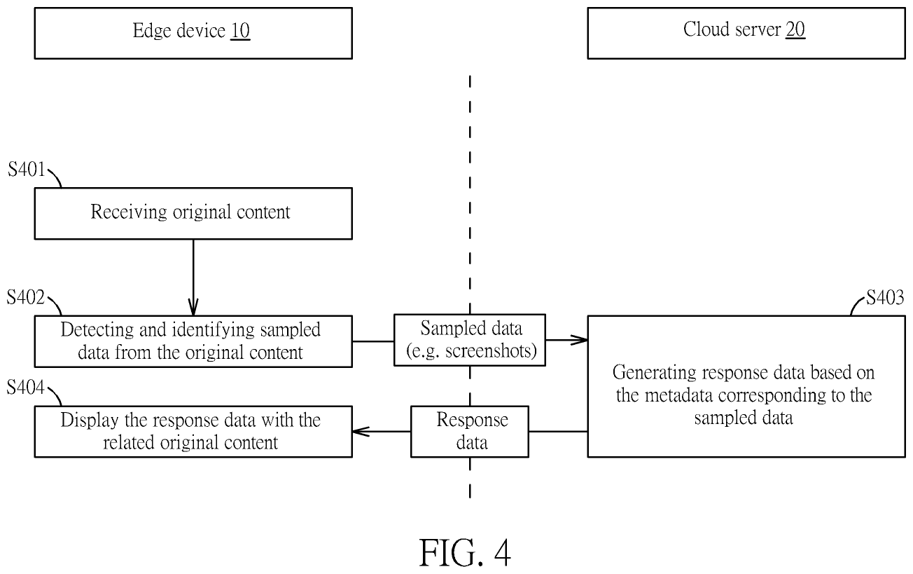

FIG. 4 is a flowchart of a method for operating the hybrid GAI deployment system 100 in FIG. 1 by transmitting sampled data as intermediate data according to an embodiment. FIG. 4 illustrates an operation in which the edge device 10 generates intermediate data in a sampled data form, the cloud server 20 generates response data based on metadata identified using the sampled data, and the response data is returned for presentation at the edge device 10. As shown in FIG. 4, the edge device 10 receives original content at step S401. The edge device 10 can receive the original content through the receiving module 10a, as previously described with reference to FIG. 1. The original content includes at least one of audio content, image content, or video content.

At step S402, the edge device 10 detects and identifies sampled data from the original content. The edge device 10 can perform step S402 by the analysis module 10b. Sampled data refers to data produced by sampling the original content, and the sampled data is used as intermediate data for transmission to the cloud server 20. The sampled data includes down-sampled data generated by reducing at least one of a spatial resolution of the original content or a temporal sampling frequency of the original content. For example, when the original content includes video content, the analysis module 10b can generate sampled data by reducing a frame resolution, by reducing a sampling frequency for selecting frames, or by a combination thereof. In another example, when the original content includes image content, the analysis module 10b can generate sampled data by reducing an image resolution. In another example, the sampled data includes image data captured from the original content as a sample of the original content. The sampled data in FIG. 4 is illustrated with “(e.g. screenshots)” as a non-limiting example, and the sampled data is not limited to screenshots.

After the sampled data is generated, the edge device 10 transmits the sampled data to the cloud server 20 as the intermediate data. The edge device 10 can transmit the intermediate data by the communication module 10c, as previously described with reference to FIG. 1. In some configurations, the communication module 10c encrypts the intermediate data before transmitting the intermediate data to the cloud server 20. In some configurations, the edge device 10 receives a user input indicating whether to transmit the intermediate data to the cloud server 20, and the edge device 10 transmits the intermediate data to the cloud server 20 in response to the user input indicating to transmit the intermediate data to the cloud server 20.

At step S403, the cloud server 20 generates response data based on metadata identified using the sampled data. The cloud server 20 can perform step S403 by the cloud service 20a. In some configurations, the cloud service 20a identifies the metadata corresponding to the sampled data, and the cloud service 20a generates the response data based on the metadata. The metadata includes meaningful information associated with the sampled data and extracted from the sampled data. The meaningful information includes at least one of an identity of a person, an identity of a celebrity, a character trait, a landmark, a scene, or a sale item that appears in the original content. The response data includes a cloud inference result generated based on the metadata. In some configurations, the response data includes related information associated with the metadata or a recommendation associated with the metadata. After the response data is generated, the cloud server 20 transmits the response data to a destination edge device. In the operation of FIG. 4, the destination edge device is the edge device 10.

At step S404, the edge device 10 presents the response data with related original content. For example, when the sampled data is generated from a portion of the original content, the edge device 10 can present the response data while the related original content is being played or presented, so that the response data is contextually associated with the portion of the original content that gave rise to the sampled data.

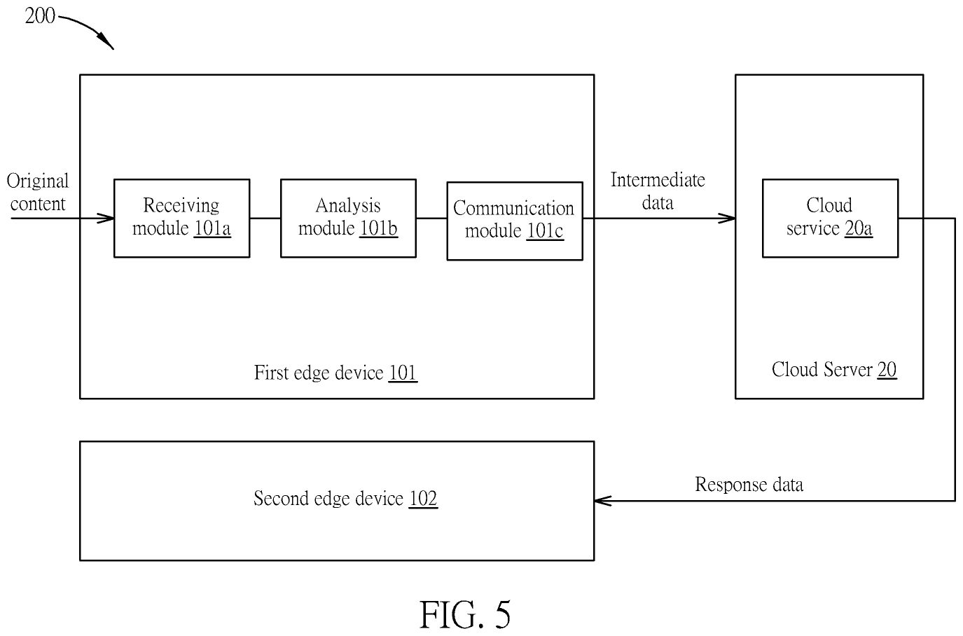

FIG. 5 is a schematic block diagram of a hybrid GAI deployment system 200 in which an edge device transmits intermediate data to a cloud server 20 and a destination edge device receives response data from the cloud server 20 according to an embodiment.

As shown in FIG. 5, the hybrid GAI deployment system 200 includes a first edge device 101, the cloud server 20, and a second edge device 102. The cloud server 20 includes a cloud service 20a. The first edge device 101 is configured to receive original content and to generate intermediate data from the original content. The first edge device 101 transmits the intermediate data to the cloud server 20. The cloud service 20a generates response data based on the intermediate data and transmits the response data to the second edge device 102. In the configuration of FIG. 5, the second edge device 102 corresponds to the destination edge device that receives the response data.

The first edge device 101 includes a receiving module 101a, an analysis module 101b, and a communication module 101c. The receiving module 101a is configured to receive original content. The original content includes at least one of audio content, image content, or video content. The first edge device 101 corresponds to a consumer device used in daily life. The consumer device includes at least one of a television, a set-top box, a mobile phone, a tablet, a personal computer, or a laptop. In one practical configuration, the first edge device 101 is a television or a set-top box that receives video content for playback.

The analysis module 101b is configured to generate intermediate data by converting data of the original content. The intermediate data is data derived from the original content and arranged for transmission to the cloud server 20. The intermediate data includes at least one form among metadata, feature information, or sampled data, as previously described with reference to FIG. 1. The analysis module 101b is configured to generate the intermediate data by detecting and identifying metadata from the original content, by detecting and identifying feature information from the original content, or by detecting and identifying sampled data from the original content. When sampled data is selected as the intermediate data, the analysis module 101b can detect and identify the sampled data by down-sampling the original content by reducing at least one of a spatial resolution of the original content or a temporal sampling frequency of the original content. The analysis module 101b can select at least one form among the metadata, the feature information, or the sampled data as the intermediate data based on an operating condition of the first edge device 101. The operating condition includes at least one of an available computing resource of the first edge device 101 or a network condition between the first edge device 101 and the cloud server 20.

The communication module 101c is configured to transmit the intermediate data from the first edge device 101 to the cloud server 20. The communication module 101c can encrypt the intermediate data before transmitting the intermediate data to the cloud server 20. In some configurations, the intermediate data transmitted from the first edge device 101 to the cloud server 20 is encrypted. Before generating the response data based on the intermediate data, the cloud server 20 can decrypt the encrypted intermediate data. After decrypting the encrypted intermediate data, the cloud service 20a can generate the response data based on the intermediate data as previously described. In some configurations, the first edge device 101 includes a user interface configured to receive a user input indicating whether to transmit the intermediate data to the cloud server 20. The communication module 101c can transmit the intermediate data to the cloud server 20 in response to the user input indicating to transmit the intermediate data to the cloud server 20.

The cloud service 20a is configured to generate the response data based on the intermediate data. When the intermediate data includes metadata, the cloud service 20a generates the response data based on the metadata. When the intermediate data includes feature information, the cloud service 20a identifies metadata based on the feature information and generates the response data based on the metadata. When the intermediate data includes sampled data, the cloud service 20a identifies metadata corresponding to the sampled data and generates the response data based on the metadata. The response data includes a cloud inference result generated based on the intermediate data. The response data can include related information associated with the metadata or a recommendation associated with the metadata.

In FIG. 5, the cloud server 20 transmits the response data to the second edge device 102 as the destination edge device. The second edge device 102 is configured to receive the response data and to display the response data. In one practical configuration, the first edge device 101 is a television and the second edge device 102 is a mobile phone, so that the response data can be presented at the mobile phone while the original content continues to be played at the television.

For example, in a cross-device collaboration scenario, the first edge device 101 is a television playing a video, and the first edge device 101 extracts feature information from the video and transmits the feature information to the cloud server 20. The cloud service 20a uses a GAI model to generate a text summary of the video based on the feature information, and then transmits the text summary as the response data to the second edge device 102, such as a mobile phone, an AR glasses device, or a smartwatch, for presentation. In another example, the first edge device 101 (e.g., a television) captures a screenshot (as sampled data) of the video and transmits the screenshot to the cloud server 20. The cloud service 20a processes the screenshot to identify metadata (e.g., identifying a product appearing in the video), compares the metadata with an online database to generate a purchase link, and transmits the purchase link as the response data to the second edge device 102 (e.g., the mobile phone, AR glasses, or smartwatch) for presentation, thereby enabling a seamless multi-screen user experience.

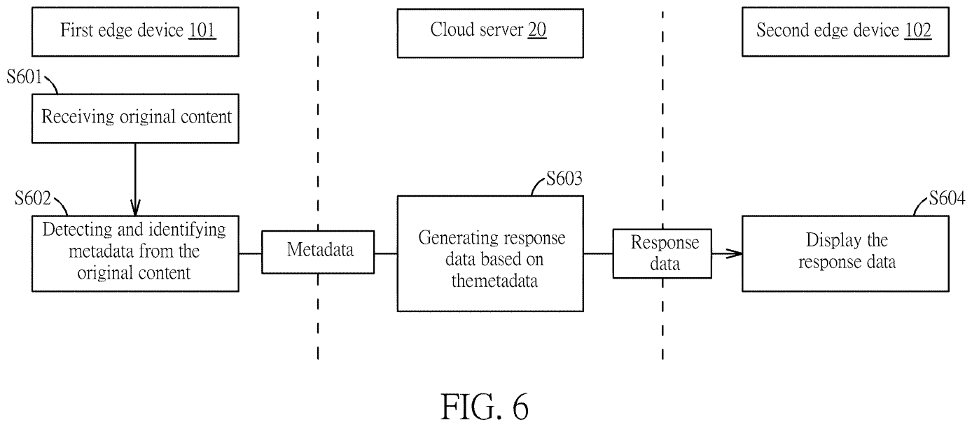

FIG. 6 is a flowchart of a method for operating the hybrid GAI deployment system 200 in FIG. 5 according to an embodiment. FIG. 6 illustrates a two-device operation in which a first edge device 101 generates intermediate data in a metadata form, a cloud server 20 generates response data based on the metadata, and a second edge device 102 receives and presents the response data. The first edge device 101, the cloud server 20 (including a cloud service 20a), and the second edge device 102 have been described above with reference to FIG. 5, and therefore are not repeated herein.

As shown in FIG. 6, the first edge device 101 receives original content at step S601. The original content includes at least one of audio content, image content, or video content. The first edge device 101 can receive the original content through the receiving module 101a.

At step S602, the first edge device 101 detects and identifies metadata from the original content. The first edge device 101 can perform step S602 by the analysis module 101b. The metadata includes meaningful information identified and extracted from the original content. The meaningful information includes at least one of an identity of a person, an identity of a celebrity, a character trait, a landmark, a scene, or a sale item that appears in the original content. In the operation of FIG. 6, the first edge device 101 generates intermediate data by converting data of the original content, and the intermediate data includes the metadata generated at step S602.

After the metadata is generated, the first edge device 101 transmits the metadata to the cloud server 20 as the intermediate data. The first edge device 101 can transmit the intermediate data by the communication module 101c. In some configurations, the communication module 101c encrypts the intermediate data before transmitting the intermediate data to the cloud server 20. In some configurations, the first edge device 101 includes a user interface configured to receive a user input indicating whether to transmit the intermediate data to the cloud server 20, and the communication module 101c transmits the intermediate data to the cloud server 20 in response to the user input indicating to transmit the intermediate data to the cloud server 20.

At step S603, the cloud server 20 generates response data based on the metadata. The cloud server 20 can perform step S603 by the cloud service 20a. The response data includes a cloud inference result generated based on the metadata. In some configurations, the response data includes related information associated with the metadata or a recommendation associated with the metadata. After the response data is generated, the cloud server 20 transmits the response data to the second edge device 102. In the operation of FIG. 6, the second edge device 102 corresponds to a destination edge device that receives the response data.

At step S604, the second edge device 102 is configured to display the response data. The second edge device 102 can display the response data as a notification, an overlay, or a dedicated presentation interface. In one configuration, the first edge device 101 continues to present the original content while the second edge device 102 presents the response data, so that a user can review the response data at the second edge device 102 without interrupting presentation of the original content at the first edge device 101.

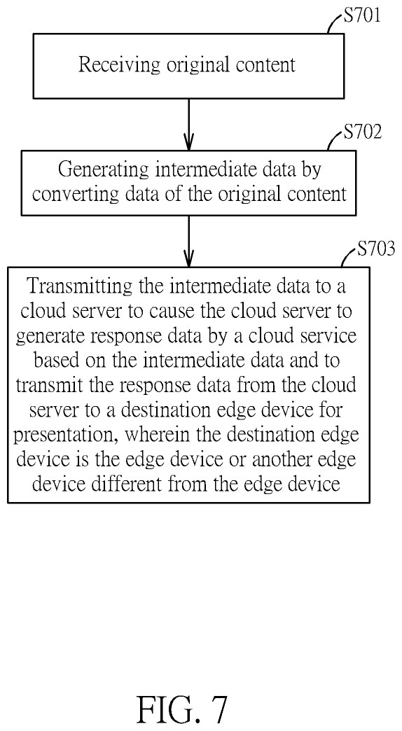

FIG. 7 is a flowchart of a method for operating the hybrid GAI deployment system 100 or 200 according to an embodiment. The method can be performed by the edge device 10, including steps S701 to S703. Any hardware or technology modification falls into the scope of the present invention Steps S701 to S703 are illustrated below

| | |
|---|---|
| step S701: | receiving original content; |
| step S702: | generating intermediate data by converting data of the original content; |
| step S703: | transmitting the intermediate data to a cloud server to cause the cloud server to |
| | generate response data by a cloud service based on the intermediate data and to |
| | transmit the response data from the cloud server to a destination edge device |
| | for presentation, wherein the destination edge device is the edge device or |
| | another edge device different from the edge device. |

Details of steps S701 to S703 have been previously described, and therefore are not repeated herein. By performing steps S701 to S703, the hybrid GAI deployment system supports interactive daily-use scenarios while balancing privacy exposure, response time, and resource usage. An edge device receives original content and converts data of the original content into intermediate data, which reduces the amount of information that needs to be transmitted off-device and permits the edge device to keep sensitive details locally. Transmitting the intermediate data to a cloud server causes the cloud server to generate response data based on the intermediate data and to transmit the response data to a destination edge device for presentation. The destination edge device can be the edge device or another edge device different from the edge device, which supports multi-screen user experiences. The step sequence also enables implementation choices such as selecting a form of the intermediate data and applying transmission controls, so the system can adapt to operating conditions and maintain a consistent user experience across different devices and network environments.

In summary, the hybrid Generative Artificial Intelligence (GAI) deployment system supports daily-use scenarios by distributing processing between an edge device and a cloud server. The edge device receives original content and generates intermediate data by converting data of the original content. The intermediate data can take a form of metadata, feature information, or sampled data, and can be selected based on an operating condition such as an available computing resource or a network condition. The edge device transmits the intermediate data to a cloud server to cause the cloud server to generate response data by a cloud service based on the intermediate data and to transmit the response data to a destination edge device for presentation. The destination edge device can be the edge device or another edge device different from the edge device. In some configurations, transmission of the intermediate data is controlled by a user input and protected by encryption, so the system can accommodate different deployment preferences while maintaining consistent operation across different devices and network environments.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A method for operating a hybrid Generative Artificial Intelligence (GAI) deployment, performed by an edge device, the method comprising:
receiving original content;
generating intermediate data by converting data of the original content; and
transmitting the intermediate data to a cloud server to cause the cloud server to generate response data by a cloud service based on the intermediate data and to transmit the response data from the cloud server to a destination edge device for presentation, wherein the destination edge device is the edge device or another edge device different from the edge device.

2. The method of claim 1, wherein generating the intermediate data comprises detecting and identifying metadata from the original content, and wherein transmitting the intermediate data comprises transmitting the metadata to the cloud server.

3. The method of claim 1, wherein generating the intermediate data comprises detecting and identifying feature information from the original content, and wherein the response data generated by the cloud server is based on metadata identified using the feature information.

4. The method of claim 1, wherein generating the intermediate data comprises detecting and identifying sampled data from the original content, and wherein the response data generated by the cloud server is based on metadata identified using the sampled data.

5. The method of claim 4, wherein detecting and identifying the sampled data comprises down-sampling the original content by reducing at least one of a spatial resolution of the original content or a temporal sampling frequency of the original content.

6. The method of claim 1, wherein generating the intermediate data comprises:
determining an operating condition comprising at least one of an available computing resource of the edge device or a network condition between the edge device and the cloud server;
selecting an intermediate data format from a plurality of formats comprising metadata, feature information, and sampled data based on the operating condition; and
generating the intermediate data in the selected intermediate data format.

7. The method of claim 1, wherein transmitting the intermediate data comprises encrypting the intermediate data before transmitting the intermediate data to the cloud server.

8. The method of claim 1, wherein transmitting the intermediate data comprises:
receiving, via a user interface of the edge device, a user input indicating whether to transmit the intermediate data to the cloud server; and
transmitting the intermediate data to the cloud server in response to the user input indicating to transmit the intermediate data to the cloud server.

9. An edge device for a hybrid Generative Artificial Intelligence (GAI) deployment, comprising:
a communication interface;
a memory storing instructions; and
at least one processor coupled to the communication interface and the memory, wherein the at least one processor is configured to execute the instructions to:
receive original content;
generate intermediate data by converting data of the original content; and
transmit, via the communication interface, the intermediate data to a cloud server to cause the cloud server to generate response data by a cloud service based on the intermediate data and to transmit the response data to a destination edge device for presentation, wherein the destination edge device is the edge device or another edge device different from the edge device.

10. The edge device of claim 9, wherein the at least one processor is configured to generate the intermediate data by detecting and identifying metadata from the original content, and to transmit the metadata to the cloud server as the intermediate data.

11. The edge device of claim 9, wherein the at least one processor is configured to generate the intermediate data by detecting and identifying feature information from the original content, and wherein the response data is generated by the cloud server based on metadata identified using the feature information.

12. The edge device of claim 9, wherein the at least one processor is configured to generate the intermediate data by detecting and identifying sampled data from the original content, and wherein the response data generated by the cloud server is based on metadata identified using the sampled data.

13. The edge device of claim 12, wherein the at least one processor is configured to detect and identify the sampled data by down-sampling the original content by reducing at least one of a spatial resolution of the original content or a temporal sampling frequency of the original content.

14. The edge device of claim 9, wherein the at least one processor is configured to generate the intermediate data by:
determining an operating condition comprising at least one of an available computing resource of the edge device or a network condition between the edge device and the cloud server;
selecting an intermediate data format from a plurality of formats comprising metadata, feature information, and sampled data based on the operating condition; and
generating the intermediate data in the selected intermediate data format.

15. The edge device of claim 9, wherein the at least one processor is configured to encrypt the intermediate data before transmitting the intermediate data to the cloud server via the communication interface.

16. The edge device of claim 9, further comprising a user interface configured to receive a user input indicating whether to transmit the intermediate data to the cloud server, wherein the at least one processor is configured to transmit, via the communication interface, the intermediate data to the cloud server in response to the user input indicating to transmit the intermediate data.

17. A method for providing a hybrid Generative Artificial Intelligence (GAI) service, performed by a cloud server, the method comprising:
receiving, from a first edge device over a network, intermediate data, wherein the intermediate data is derived from original content processed by the first edge device;
generating response data by a cloud service hosted on the cloud server based on the intermediate data; and
transmitting the response data to a destination edge device to cause the destination edge device to present the response data, wherein the destination edge device is the first edge device or a second edge device different from the first edge device.

18. The method of claim 17, wherein the intermediate data received from the first edge device comprises metadata extracted from the original content, and wherein the response data is generated based on the metadata.

19. The method of claim 17, wherein the intermediate data received from the first edge device comprises feature information detected from the original content, and wherein generating the response data comprises:
identifying metadata based on the feature information; and
generating the response data based on the metadata.

20. The method of claim 17, wherein the intermediate data received from the first edge device comprises sampled data down-sampled from the original content, and wherein generating the response data comprises:
identifying metadata using the sampled data; and
generating the response data based on the metadata.

21. The method of claim 17, wherein the intermediate data is received in an intermediate data format dynamically selected by the first edge device from a plurality of formats comprising metadata, feature information, and sampled data based on an operating condition of the first edge device.

22. The method of claim 17, wherein the intermediate data received from the first edge device is encrypted, and the method further comprises decrypting the intermediate data prior to generating the response data.
